(19) United States
(12) Patent Application Publication
(10) Pub. No.: US 2025/0242881 A1
(43) Pub. Date: Jul. 31, 2025

(54) FASTENER ASSEMBLY

(71) Applicant: BOMBARDIER RECREATIONAL PRODUCTS INC., Valcourt (CA)

(72) Inventors: Samuel SIMONEAU, St-Denis-de-Brompton (CA); Pierre-Luc ROBILLARD, Sherbrooke (CA); Anne-Marie DION, Shefford (CA)

(21) Appl. No.: 19/037,449

(22) Filed: Jan. 27, 2025

Related U.S. Application Data
(60) Provisional application No. 63/627,506, filed on Jan. 31, 2024.

(51) Int. Cl. B62K 25/02; B62M 9/02; F16B 39/28

(52) U.S. Cl. CPC B62K 25/02; F16B 39/28; B62M 9/02

(57) ABSTRACT

A fastener assembly comprises a fastener having a fastener outer periphery, a fastener inner periphery defining an opening for receiving a shaft, an end face disposed between the fastener inner and outer peripheries; a retaining member having an outer periphery, an inner periphery defining an opening for receiving the shaft; and an end face disposed between the outer and inner peripheries. The end face of the retaining member faces the end face of the fastener. A projection extends from one of: the end face of the fastener and the end face of the retaining member. A recess is defined in an other of: the end face of the fastener and the end face of the retaining member, the recess being sized and shaped to receive the projection.

CROSS-REFERENCE

The present patent application claims priority from U.S. patent application U.S. 63/627,506 filed 31 Jan. 2024 entitled “Fastener Assembly”, which is incorporated herein by reference in its entirety.

### FIELD OF TECHNOLOGY

The present technology relates to fastener assemblies, such as, but not limited to fastener assemblies used in drivetrains of vehicles, and vehicles having same.

### BACKGROUND

Motorcycles typically have a front wheel and a rear wheel, with the rear wheel being driven by a motor, such as an internal combustion engine or an electric motor. The rear wheel is often connected to the frame of the motorcycle via a swingarm. The swingarm can be a double-sided swingarm or a single-sided swingarm. In a double-sided swingarm, the swingarm has two arms and the rear wheel is rotationally supported between the two arms. In a single-sided swingarm, the rear wheel is rotationally connected to one side of an arm of the swingarm in a cantilevered fashion.

A drivetrain is operatively connected between the motor and the rear wheel for driving the rear wheel from the motor. In many motorcycles, the drivetrain includes a wheel axle including a threaded nut for maintaining components on the wheel axle. However, the threaded nut could loosen due to one or more of: to the rotation of the shaft and forces acting on the wheel axle, such as shock; vibration; environmental factors such as temperature changes causing unequal expansion between different components; and changes in direction of the mechanical power transfer which can rapidly switch.

One existing solution for avoiding loosening of the nut comprises drilling a hole in the wheel axle and nut, inserting a cotter pin through the hole and bending the cotter pin to hold the nut in place relative to the axle.

Another solution comprises attaching a separate component, such as a lock ring, to the nut to secure the nut and to avoid its loosening.

In yet another approach, a nylon ring is placed inside the nut, which deforms when it is threaded and stops the nut from becoming loose. However, the nylon ring is subject to degradation and, as it deforms, its effectiveness is thus reduced over time.

Other existing methods involve deforming the threads or the nut to hold it in place, or applying locking fluid but these methods are not reusable or require application of a special liquid on the nut and bolt.

Although such existing methods of holding nuts can be effective, they require additional components and additional assembly and disassembly steps, which can increase cost and reduce efficiency of these tasks. Furthermore, they are often not very robust nor reusable.

An additional consideration is when the nut is used in a drivetrain, or other place in a vehicle, which is not readily accessible or is otherwise hidden from view. This makes it more difficult to inspect the nut for loosening and in such uses, locking of the nut to avoid its loosening is even more important.

There is therefore a desire for a fastening system that addresses the above problems.

### SUMMARY

It is an object of the present technology to ameliorate at least some of the inconveniences present in the prior art.

From one aspect, there is provided a fastener assembly comprising: a fastener configured to fit around a shaft, the fastener having: a fastener body having a fastener outer periphery, and a fastener inner periphery defining a fastener opening for receiving the shaft; an end face being disposed between the fastener inner periphery and the fastener outer periphery; a retaining member configured to fit around the shaft, the retaining member having: a retaining member body having a retaining member outer periphery, and a retaining member inner periphery defining a retaining member opening for receiving the shaft; and an end face disposed between the retaining member outer periphery and the retaining member inner periphery, the end face of the retaining member body facing the end face of the fastener body; at least one projection extending from one of: the end face of the fastener body and the end face of the retaining member body; and at least one recess defined in an other of: the end face of the fastener body and the end face of the retaining member body, the at least one recess being sized and shaped to receive the at least one projection.

In certain embodiments, the inner periphery of the retaining member defines internal splines for engaging external splines defined on the shaft.

In certain embodiments, at least a portion of the fastener inner periphery defines threads, the threads being configured to engage with a threaded portion of the shaft.

In certain embodiments, the at least one projection comprises two projections separated by a fastener groove.

In certain embodiments, the at least one projection extends from the end face of the fastener body and the at least one recess is defined in the end face of the retaining member body.

In certain embodiments, the at least one projection extends axially from the end face of the fastener.

In certain embodiments, the at least one recess is positioned radially outwardly from the retaining member inner periphery and extends circumferentially about the end face of the retaining member body.

In certain embodiments, the retaining member comprises at least one alignment indicator on another end face of the retaining member, the other end face being disposed between the retaining member outer periphery and the retaining member inner periphery opposite the end face, the at least one alignment indicator indicating a position of a predetermined portion of the at least one recess on the end face. In certain embodiments, the at least one alignment indicator is aligned with a spline of the retaining member.

In certain embodiments, the predetermined portion is an edge portion or a central portion of the at least one recess.

In certain embodiments, the at least one recess comprises a plurality of recesses formed in the end face of the retaining member body, the plurality of recesses being spaced apart circumferentially by separator members.

In certain embodiments, each separator member has a width which increases with increasing radial distance from the inner periphery of the retaining member.

In certain embodiments, the retaining member comprises a plurality of alignment indicators on another end face of the retaining member, the other end face being disposed between the retaining member outer periphery and the retaining member inner periphery opposite the end face, the plurality of alignment indicators indicating a position of an edge portion or a central portion of the at least one recess on the end face.

In certain embodiments, the fastener body has an other end face between the fastener inner periphery and the fastener outer periphery and opposite the end face, the other end face being configured to abut an object to retain the object, wherein the end face with the at least one projection is not configured to abut the object.

In certain embodiments, the fastener is an axle nut, the retaining member is a sprocket, and the shaft is a wheel axle.

In certain embodiments, the fastener is connected to a reluctor ring.

From another aspect, there is provided a fastener for a fastener assembly including a retaining member, the fastener comprising: a fastener body having a fastener outer periphery, a fastener inner periphery defining a fastener opening for receiving a shaft, and an end face disposed between the fastener inner periphery and the fastener outer periphery; and at least one projection extending from the end face of the fastener body.

In certain embodiments, the at least one projection extends axially from the end face of the fastener body.

In certain embodiments, at least a portion of the fastener inner periphery defines threads, the threads being configured to engage with a threaded portion of the shaft.

In certain embodiments, the fastener is an axle nut and the shaft is a wheel axle.

From a yet further aspect, there is provided a method for assembling a fastener assembly onto a shaft, the method comprising: positioning an internally threaded fastener on the shaft such that the shaft extends through a fastener opening of the fastener, the fastener having a body with a fastener outer periphery, a fastener inner periphery defining the fastener opening, an end face disposed between the fastener inner periphery and the fastener outer periphery; screwing the fastener on the shaft; and positioning a retaining member on the shaft, the retaining member having a retaining member body with a retaining member outer periphery, a retaining member inner periphery defining the retaining member opening, an end face disposed between the retaining member outer periphery and the retaining member inner periphery, such that: the shaft extends through a retaining member opening of the retaining member; the retaining member is rotationally fixed relative to the shaft; and at least one projection extending from one of: the end face of the fastener body and the end face of the retaining member body is received in at least one recess defined in an other of: the end face of the fastener body and the end face of the retaining member body.

In certain embodiments, the at least one projection extends from the end face of the fastener body and the at least one recess is defined in the end face of the retaining member body, and positioning the retaining member comprises aligning an alignment indicator on another end face of the retaining member body with the at least one projection of the fastener, the other end face being disposed between the retaining member outer periphery and the retaining member inner periphery opposite the end face, and optionally wherein positioning the retaining member comprises engaging internal splines of the retaining member with external splines of the shaft.

In certain embodiments, the alignment indicator is lined up with a visual indicator of the at least one projection of the fastener, while the fastener is being tightened. In certain embodiments, the visual indicator of the at least one projection is a groove between two projections. According to certain embodiments, the fastener assembly provides a locking feature on the fastener, which can be a nut, which avoids the use of additional locking components of the prior art such as cotter pins, nylon rings etc.

Furthermore, the fastener assembly is robust and reusable. The fastener assembly can be readily assembled and disassembled without requiring additional tools or other components.

Embodiments of the fastener assembly eliminate the need to check whether the fastener has loosened over a time of operation of the nut. This is particularly advantageous when the fastener assembly is used in sealed environments such as a sealed drivetrain. The seal can remain undisturbed thereby increasing its lifespan. Furthermore, when the fastener assembly is used in oil-filled environments (such as swingarms with oil baths), it is even more advantageous to not have to access that environment. Oil also has certain chemical incompatibilities which consideration is avoided by avoiding locking chemicals.

For purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle according to the present technology;

FIG. 2 is a close-up left side elevation view of a drivetrain and a rear wheel of the vehicle of FIG. 1;

FIG. 3 is a close-up perspective view taken from a rear, left side of the drivetrain and the rear wheel of FIG. 2, with a cover of a housing of the drivetrain removed;

FIG. 4 is a top plan view of the drivetrain of FIG. 2 with the rear wheel removed;

FIG. 5 is a left side elevation view of the drivetrain of FIG. 4;

FIG. 6 is a cross-sectional view of the drivetrain of FIG. 5, taken through line A-A of FIG. 5;

FIG. 7 is an exploded view of the components of FIG. 4 and including the rear wheel;

FIG. 8 is a close-up perspective view taken from a rear, left side of a rear wheel axle and driven belt sprocket of the drivetrain of FIG. 3;

FIG. 9 is the close-up perspective view of FIG. 8 with the driven belt sprocket removed so that a nut is visible;

FIG. 10 is a close-up perspective view taken from the right side of the nut of FIG. 9 when it is attached to the driven belt sprocket of FIG. 8;

FIG. 11 is a perspective view taken from the left side of the nut of FIG. 9;

FIG. 12 is a rear view of the nut of FIG. 9;

FIG. 13 is the rear view of the nut of FIG. 9 when it is rotated by 90 degrees;

FIG. 14 is a perspective view taken from the right side of the nut of FIG. 9;

FIG. 15 is a plan view taken from the right side of the nut of FIG. 9 with components on the left side of the nut shown in dotted lines;

FIG. 16 is a perspective view taken from the right side of the driven belt sprocket of FIG. 8;

FIG. 17 is a perspective view taken from the left side of the driven belt sprocket of FIG. 8; and

FIG. 18 is a plan view taken from the right side of the driven belt sprocket of FIG. 9 with components on the left side of the driven belt sprocket shown as dotted lines.

It should be noted that, unless otherwise explicitly specified herein, the drawings are not necessarily to scale.

### DETAILED DESCRIPTION

The present technology will be described herein with respect to a straddle-seat electric vehicles, specifically a motorcycle 100. Aspects of the present technology could also be implemented in different vehicles and other mechanical devices having a flexible drive member.

While the motorcycle 100 illustrated herein is a trail style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

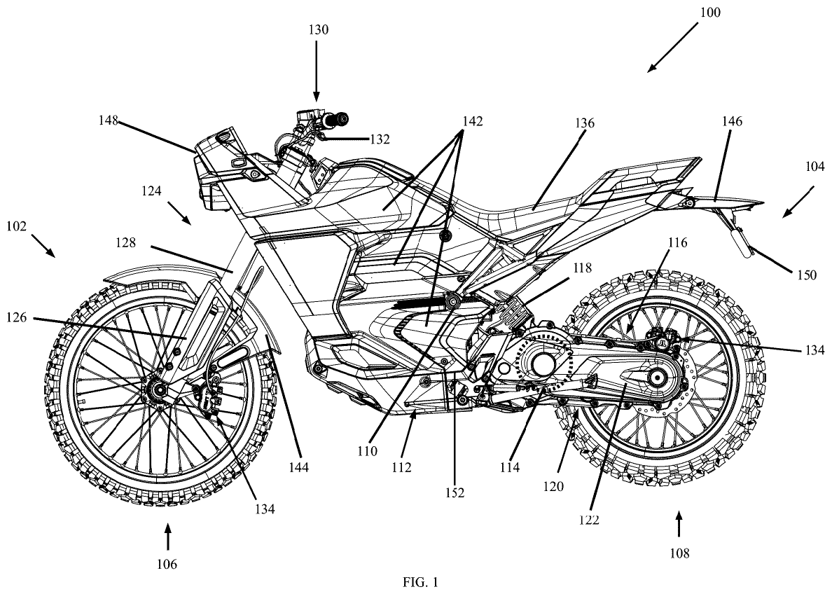

With reference to FIG. 1, the motorcycle 100, referred to hereinafter as the vehicle 100, has a front end 102 and a rear end 104 defined consistently with the forward travel direction of the vehicle 100. The vehicle 100 is a two-wheeled vehicle 100 including a front wheel 106 and a rear wheel 108. The front wheel 106 and the rear wheel 108 each have a tire secured thereto.

A battery pack 110 is arranged in the vehicle 100 between the front wheel 106 and the rear wheel 108. In the present embodiment, the battery pack 110 forms part of the frame 112 of the vehicle 100. A charger (not shown) is electrically connected to the battery pack 110, and is disposed on a top of the battery pack 110. It is contemplated that the location of the charger relative to the battery pack 110 could vary. An inverter (not shown) is electrically connected to the battery pack 110, and is disposed on a left side of the battery pack 110. It is contemplated that the location of the charger relative to the battery pack 110 could vary.

An electric motor 114 (shown schematically in FIG. 1) is operatively connected to the rear wheel 108 to drive the rear wheel. The electric motor 114 is mounted to a swingarm 116. It is contemplated that in some embodiments, the electric motor 114 could be mounted to the frame 112. The swingarm 116 is pivotally connected at its front to the frame 112. The rear wheel 108 is rotationally connected to the rear portion of the swingarm 116. A shock absorber 118 is connected between the swingarm 116 and the frame 112. Electric power is provided to the motor 114 by the battery pack 110 via the inverter. The motor 114 drives the rear wheel 108 via a drivetrain 120. The swingarm 116 defines a housing 122 of the drivetrain 120. The drivetrain 120 will be described in more detail below. In the present embodiment, the motor 114 is a three-phase electric motor 114. It is contemplated that different types of motors could be used in some embodiments. It is also contemplated that in some embodiments, the electric motor 114 could be replaced by a different type of motor, such as a two-stroke or four-stroke internal combustion engines. In such embodiments, the battery pack 110 would be omitted and the vehicle 100 would be provided with a fuel tank, an air intake system, an exhaust system, and other components required for the operation of an internal combustion engine.

The front wheel 106 is connected to the frame 112 by a front suspension assembly 124. The front wheel 106 is rotationally connected to the front suspension assembly 124. The front suspension assembly 124 includes a front fork assembly 126 and a pair of front shocks 128.

A handlebar assembly 130 is operatively connected to the front suspension assembly 124. The handlebar assembly 130 is used to turn the front wheel 106, via the front suspension assembly 124. A twist-grip throttle (not shown) is operatively connected on the right side of the handlebar assembly 130 for controlling vehicle speed. It is contemplated that the twist-grip throttle could be replaced by a thumb throttle lever or some other type of throttle input device. A brake lever 132 is operatively connected on a right side of the handlebar assembly for activating brake assemblies 134 of the front and rear wheels 106, 108.

A straddle seat 136 is connected to a top of the frame 112. In the present embodiment, the straddle seat 136 is sized to accommodate a single adult-sized rider (i.e., the driver). It is however contemplated that the seat 136 could be longer or that a passenger seat portion could be connected to the frame 112 in order to accommodate a passenger behind the driver.

A plurality of body panels 142 are connected to the frame 112 for forming the body of the vehicle 100. The body panels 142 enclose and protect some internal components of the vehicle 100. A front fender 144 is disposed at the front of the vehicle 100 and extends partially over the front wheel 106. A rear fender panel 146 extends partially over rear wheel 108. Front headlights 148 are attached to the front suspension assembly 124. Rear braking and indicator lights 150 are connected to the rear fender panel 146. Footrests 152 are connected to the frame 112 on either side of the vehicle 100 vertically lower than the straddle seat 136 to support the driver's feet. A brake pedal (not shown) is connected to the right driver footrest 152 (not shown) for braking the vehicle 100.

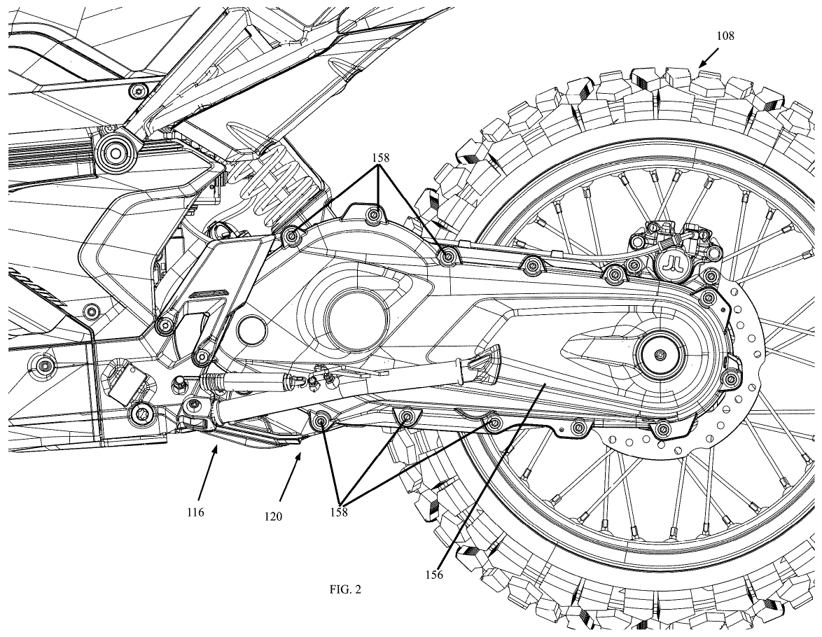

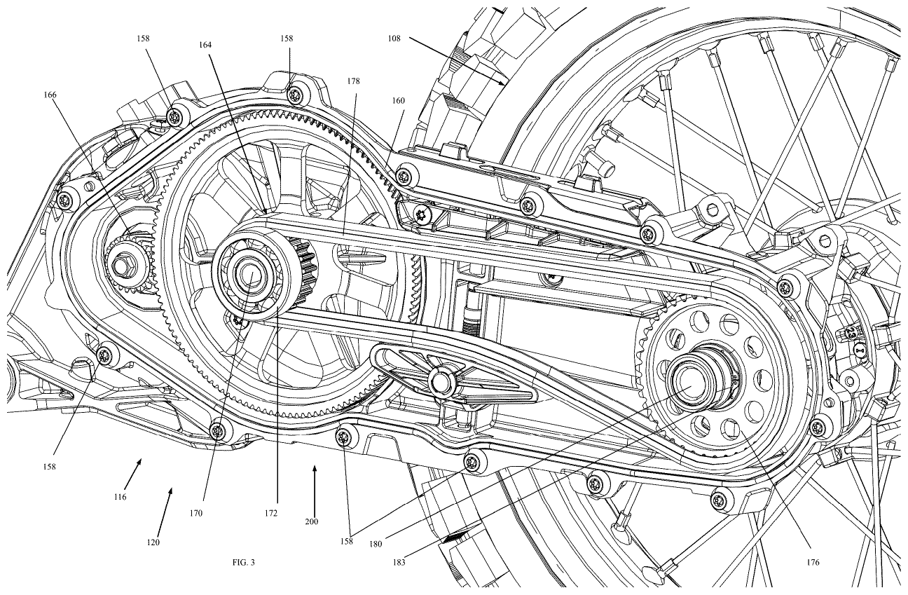

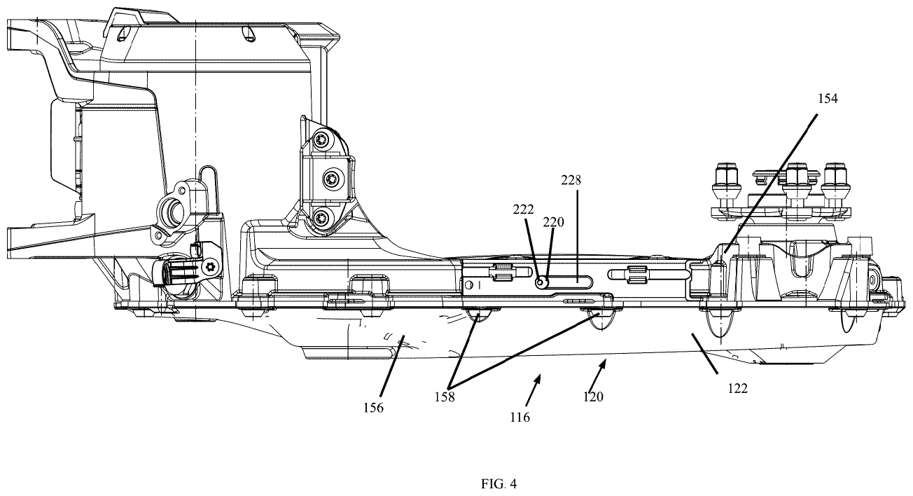

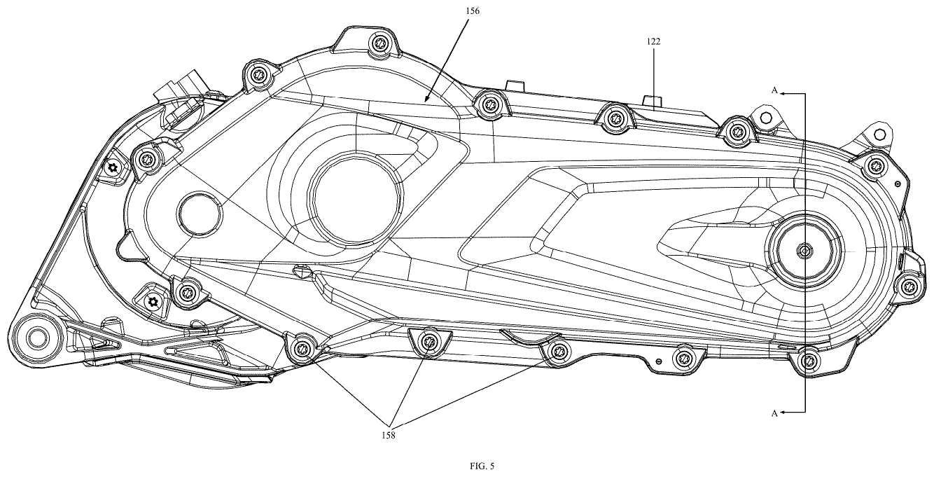

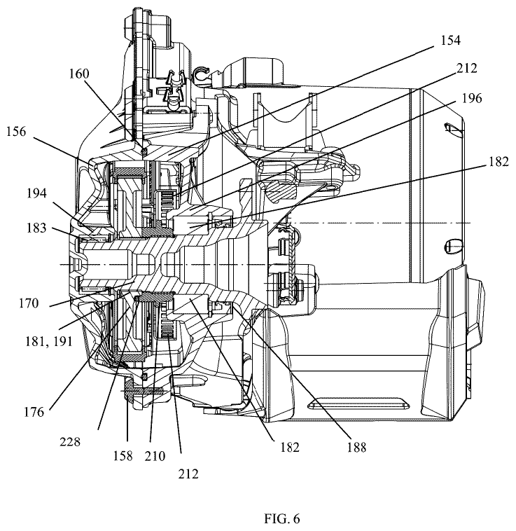

Turning now to FIGS. 2 to 6, the drivetrain 120 will be described in more detail. As described above, the drivetrain 120 has a housing 122 that is defined by the swingarm 116. The housing 122 has a main housing portion 154 and a removable housing cover 156 fastened to the main housing portion 154 by threaded fastener 158. A seal 160 (FIGS. 3 and 6) is provided in a groove along an edge of the main housing portion 154 to seal the interface between the main housing portion 154 and the housing cover 156 to prevent oil present inside the housing 122 from leaking out of the housing 122 via this interface. The motor 114 is fastened to a front right side of the main housing portion 154. The rear wheel 108 is rotationally connected to a rear right side of housing 122, behind the motor 114. Referring to FIG. 3, the drivetrain 120 also includes a gear assembly 162, a drive belt assembly 164 driven by the gear assembly 162, and a tensioner system 200 which are disposed inside the housing 122.

The gear assembly 162 includes drive gear 166 mounted on an output shaft (not shown) of the motor 114 and a driven gear 168 mounted on an axle 170. The drive gear 166 meshes with the driven gear 168 to transfer torque from the motor 114 to the driven gear 168. As can be seen, the driven gear 168 has a greater diameter than the drive gear 166, such that the driven gear 168 turns slower than the drive gear 166, and therefore slower than the output shaft of the motor 114. The axle 170 engages the driven gear 168 with splines such that the driven gear and the axle 170 turn at the same speed. The axle 170 is rotationally supported at its right and left ends by right and left bearing 172 respectively (only the left bearing 172 being shown). The right bearing is supported in a ring (not shown) defined by a right wall of the main housing portion 154. The left bearing 172 is supported in a ring (not shown) defined by a left wall of the housing cover 156. It is contemplated that a different type of gear assembly could be provided instead of the gear assembly 162. It is also contemplated that a speed reduction mechanism other than a gear assembly could be provided instead of the gear assembly 162, such as another drive belt assembly for example. It is also contemplated that the gear assembly, or an alternative speed reduction mechanism, could be provided outside of the housing 122, such as between the housing 122 and the motor 114 or inside the housing (not shown) of the motor 114. It is also contemplated that in some embodiments, the gear assembly 162 could be omitted.

The drive belt assembly 164 includes a drive wheel 174, a driven wheel 176 and a flexible drive member 178 engaging the drive wheel 174 and the driven wheel 176 for transmitting torque between the drive wheel 174 and the driven wheel 176. In the drive belt assembly 164, the drive wheel 174 is a drive belt sprocket 174, the driven wheel 176 is a driven belt sprocket 176 and the flexible drive member 178 is a drive belt 178. In the present embodiment, the drive belt 178 is a toothed elastomeric drive belt, such as a rubber drive belt, but other materials are contemplated. It is contemplated that in alternative embodiments, the drive belt assembly 164 could be replaced by a drive chain assembly in which the drive wheel is a drive chain sprocket, the driven wheel is a driven chain sprocket, and the flexible drive member is a drive chain. It is also contemplated that in other alternative embodiments, the drive belt assembly 164 could be replaced by a pulley assembly in which the drive wheel is a drive pulley, the driven wheel is a driven pulley, and the flexible drive member is a V-belt.

The drive belt sprocket 174 is mounted on the axle 170 via the splines on the axle 170. As such, the drive belt sprocket 174 turns at the same speed as the driven gear 168 and the axle 170. The drive belt sprocket 174 is disposed laterally between the left bearing 172 and the driven gear 168. The drive belt sprocket 174 has a diameter that is greater than the diameter of the drive gear 166 and smaller than the diameter of the driven gear 168. The drive belt 178 is disposed around the drive belt sprocket 174 and the driven belt sprocket 176.

The tensioner system 200 pushes up against a bottom of a lower portion of the drive belt 178 for tensioning the drive belt 178. It is contemplated that in alternative embodiments, the tensioner system 200 could be positioned and configure to push down against a top of the lower portion of the drive belt 178, or to push up against a bottom of an upper portion of the drive belt 178, or to push down against a top of the upper portion of the drive belt 178.

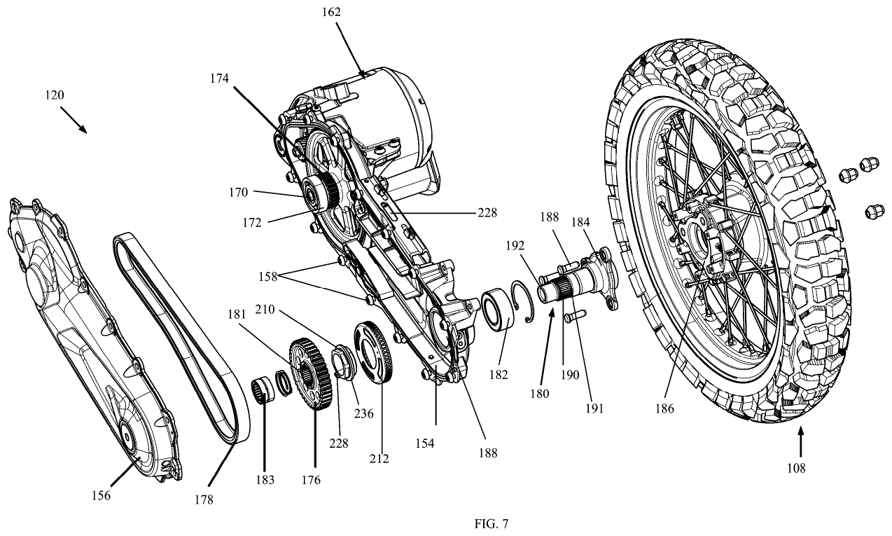

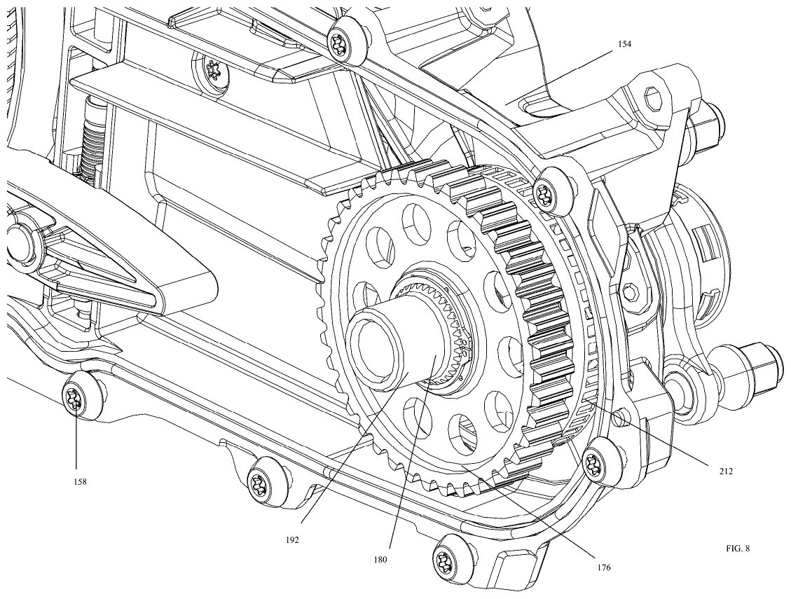

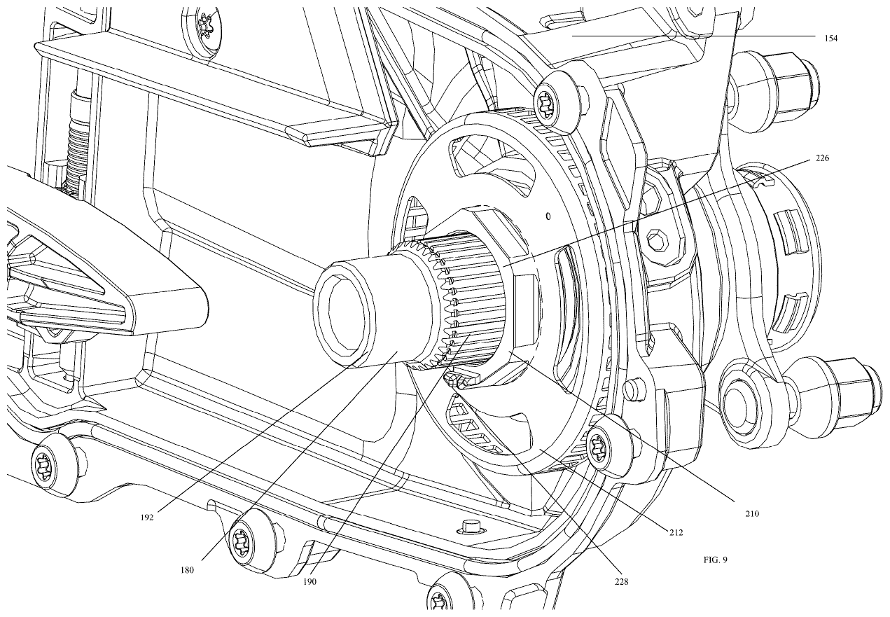

Referring now to FIGS. 6 to 9, the driven belt sprocket 176 is mounted on a rear wheel axle 180 via internal splines 181 of the driven belt sprocket 176. The rear wheel axle 180 has a base 184, at a right end, which is connected to a hub 186 of the rear wheel 108 by fasteners 188. The rear wheel 108 is mounted on the right end of the rear wheel axle 180. The rear wheel axle 180 extends through an opening 188 of the main housing portion 154.

Spaced axially from the base 184 is a spline portion 190 of the rear wheel axle 180 comprising external splines 191. The external splines 191 extend axially and are circumferentially spaced from one another. The external splines 191 of the rear wheel axle 180 engage with the internal splines 181 of the driven belt sprocket 176. A free end 192 of the rear wheel axle 180, at the left end, is free of external splines, the spline portion 190 being disposed between the free end 192 and the base 184.

The rear wheel axle 180 is rotationally supported by right and left bearings 182, 183. The left bearing 183 is supported between the free end 192 of the rear wheel axle 180 and a ring 194 (FIG. 6) defined by a left wall of the housing cover 156. The right bearing 182 is supported in a ring 196 (FIG. 6) defined by a right wall of the main housing portion 154, and a portion of the rear wheel axle 180 between the base 184 of the rear wheel axle 180 and the spline portion 190, which is disposed laterally between the rear wheel 108 and the driven belt sprocket 176.

A nut 210 is disposed on the rear wheel axle 180, to the left of the right bearing 182 and to the left of the drive belt sprocket 176. The nut 210 has internal threads which engage with a threaded portion of the rear wheel axle 180. A reluctor ring 212 is disposed on the rear wheel axle 180, and abuts the nut 210. The reluctor ring 212 and the nut 210 may be separate components or a single component.

As will be described below, as well as being engaged with the rear wheel axle 180, the nut 210 is configured to engage with the driven belt sprocket 176. The nut and the driven belt sprocket 176 define a fastener assembly in which a position of the nut 210 on the rear wheel axle 180 is locked.

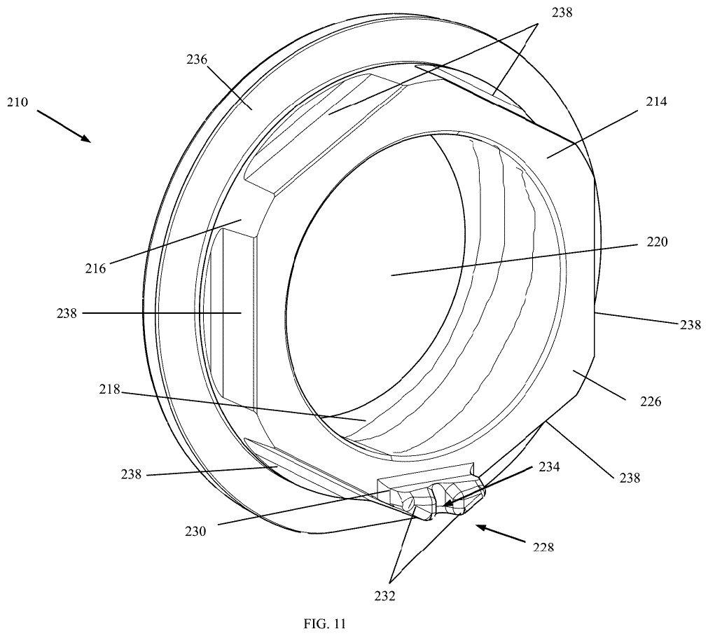

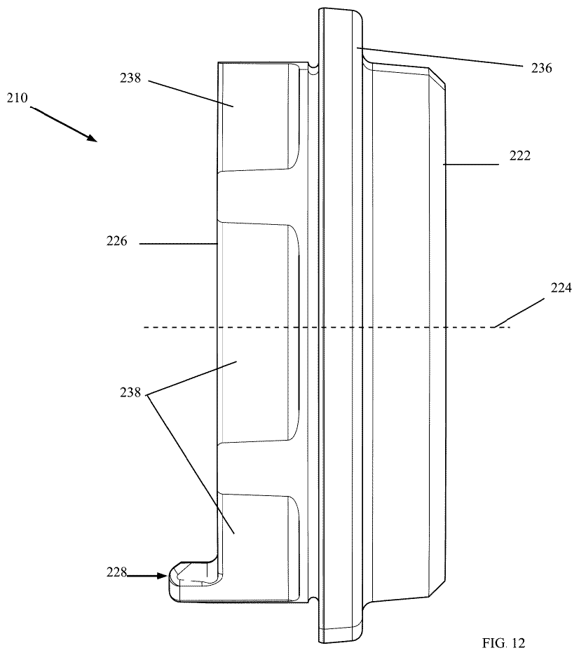

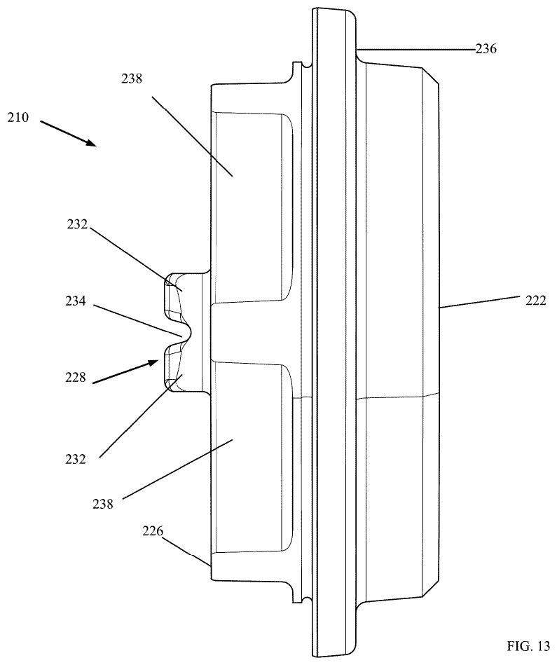

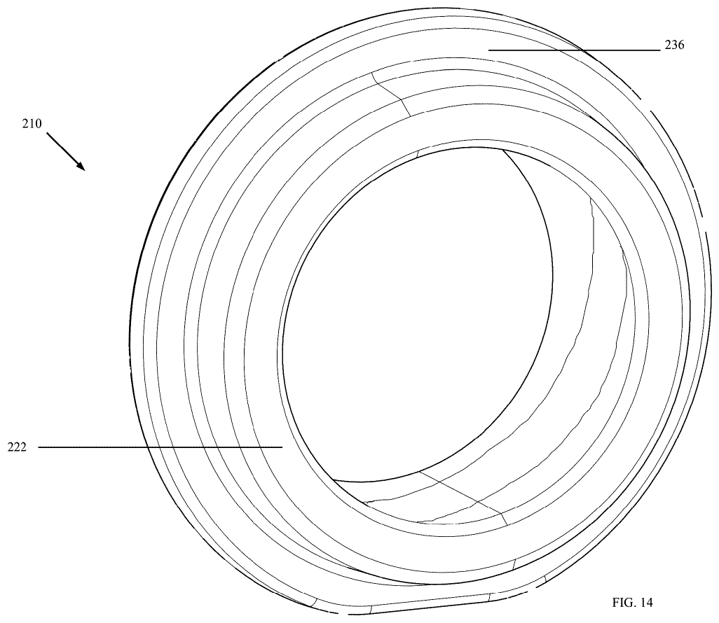

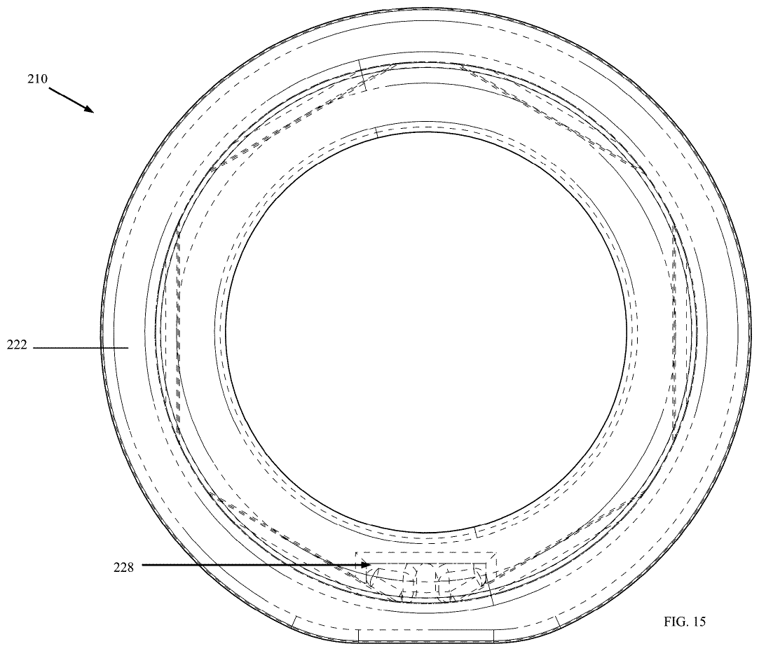

Referring to FIGS. 11 to 15, the nut 210 comprises a nut body 214 having a nut outer periphery 216, and a nut inner periphery 218 defining a nut opening 220 for receiving the rear wheel axle 180. The nut inner periphery 218 has a circular profile. At a right end, the nut 210 has a right end face 222, which is disposed between the nut inner periphery 218 and the nut outer periphery 216. The right end face 222 has a circular profile and is substantially orthogonal to a nut axis 224. At a left end, the nut 210 has a left end face 226, disposed between the nut inner periphery 218 and the nut outer periphery 216. The left end face 226 is substantially orthogonal to the nut axis 224. A projection 228 extends axially from the left end face 226 of the nut 210. The projection 228 comprises a base portion 230 extending from the left end face 226, and two finger portions 232 extending from the base portion 230. The two finger portions 232 define a groove 234 therebetween. The groove 234 can be used to align the projection 228 with the internal spline 181 of the driven belt sprocket 176. The left end face 226 is planar other than the projection 228. The left end face 226 is not configured to abut an object for the purposes of retaining the object thereof.

It will be appreciated that any other type of fastener having a projection extending from an end face can be used as the nut 210. As such, the nut body 214, the nut outer periphery 216, the nut inner periphery 218, and the nut opening 220 can be considered as a fastener body 214, a fastener outer periphery 216, a fastener inner periphery 218, and a fastener opening 220, respectively. The groove 234 can be considered as a fastener groove 234.

A flange 236 extends radially from the nut outer periphery 216. The flange 236 is disposed between the left end face 226 and the right end face 222 of the nut 210. When the nut 210 is disposed on the rear wheel axle 180, the reluctor ring 212 is disposed on a left side of the flange 236. To the left of the flange 236, the nut outer periphery 216 is multi-faceted having defined therein six sides 238 with which a tool (not shown) can engage to loosen or tighten the nut 210. The nut outer periphery 216 may have any other number of sides. The projection 228 extends between and saddles two adjacent sides 238. A profile of the flange 236 is mostly circular other than a portion radially aligned with the projection 228 where the circular profile is flattened.

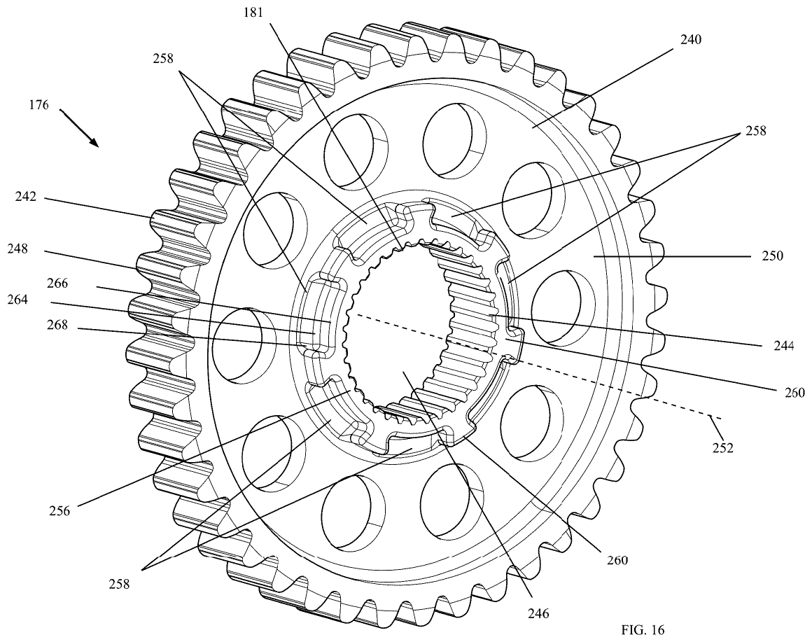

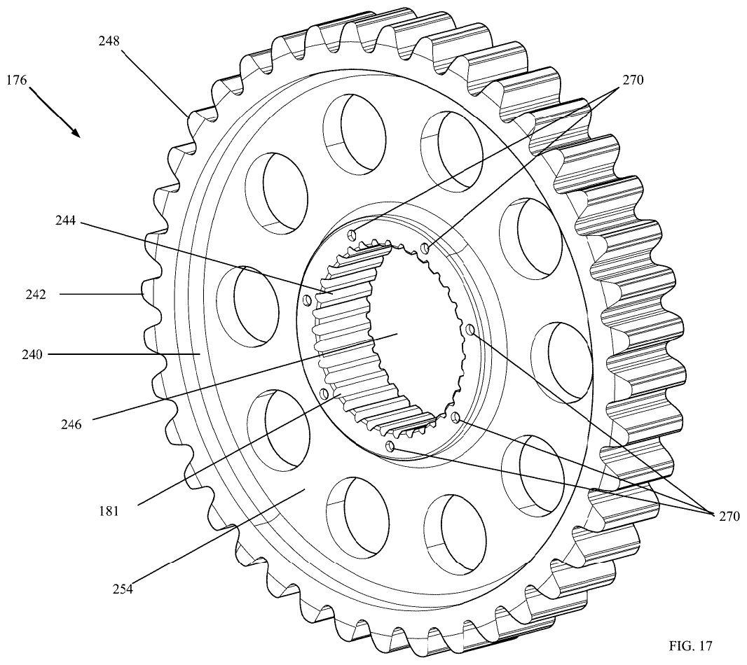

Turning now to FIGS. 16 to 18, the driven belt sprocket 176 comprises a sprocket body 240 having a sprocket outer periphery 242, and a sprocket inner periphery 244 defining a sprocket opening 246 for receiving the rear wheel axle 180. The sprocket inner periphery 244 has the internal splines 181 defined therein. The sprocket outer periphery 242 has teeth 248 defined thereon. At a right end, the driven belt sprocket 176 has a right end face 250, which is disposed between the sprocket inner periphery 244 and the sprocket outer periphery 242. The right end face 250 is substantially orthogonal to a sprocket axis 252. At a left end, the driven belt sprocket 176 has a left end face 254, disposed between the sprocket inner periphery 244 and the sprocket outer periphery 242. The left end face 254 is substantially orthogonal to sprocket nut axis 252. When assembled, the right end face 250 of the driven belt sprocket 176 faces the left end face 254 of the nut 210. It will be appreciated that any other type of retaining member having internal splines and at least one recess on an end face can be used as the driven belt sprocket 176. As such, the sprocket body 240, the sprocket outer periphery 242, the sprocket inner periphery 244, and the sprocket opening 246 can be considered as a retaining member body 240, a retaining member outer periphery 242, a retaining member inner periphery 244, and a retaining member opening 246, respectively.

As best seen in FIG. 16, the right end face 250 of the driven belt sprocket 176 has a sprocket hub portion 256 that is axially raised. A plurality of recesses 258 are defined in the sprocket hub portion 256, the plurality of recesses 258 being spaced apart circumferentially by separator members 260. In other embodiments, the sprocket hub portion 256 may be omitted. Each recess 258 is positioned radially outwardly from the sprocket inner periphery 244 and extends circumferentially about the right end face 250 of the sprocket body 240. Each separator member 260 has a width 262 which increases with increasing radial distance from the sprocket inner periphery 244. Each recess 258 is sized and shaped to receive the projection 228 of the nut 210. Each recess 258 has a left wall 264, a right wall 266 and two end walls 268.

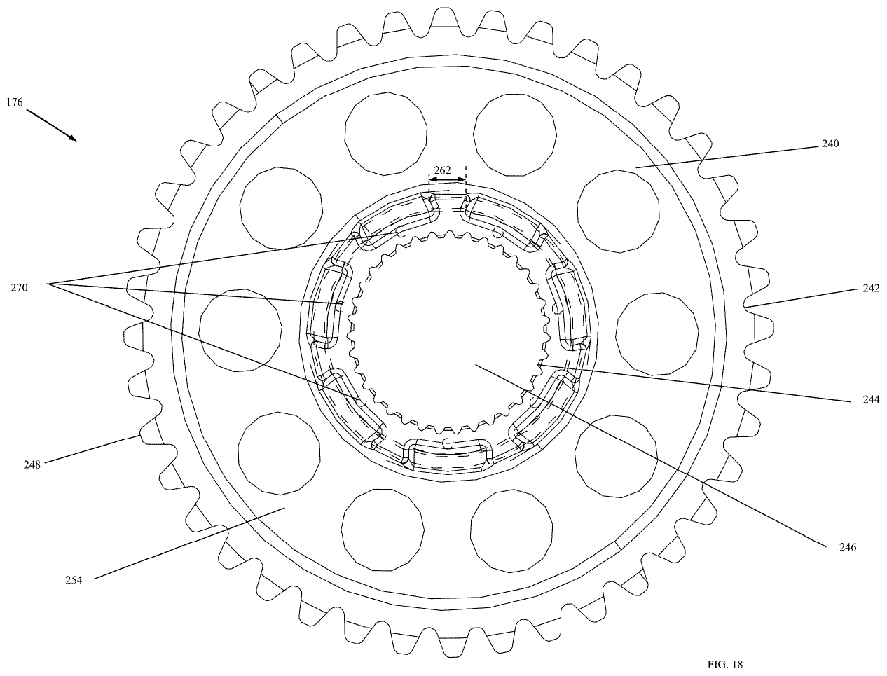

At the left end face 254 of the driven belt sprocket 176, there are provided a plurality of alignment indicators 270 spaced circumferentially from one another and at a same radial distance from the sprocket inner periphery 244. As best seen in FIG. 18, each alignment indicator 270 is aligned with a central part of the base wall 264 of a respective recess 258. Furthermore, each alignment indicator 270 is aligned with a respective internal spline 181 of the driven belt sprocket 176/The alignment indicators 270 thus can allow the alignment of the spline 181 with the groove 234 of the nut 210. The alignment indicator 270 may also be useful in indicating a position of the recess 258 on the right end face 250 of the driven belt sprocket 176 which can be helpful in aligning the projection 228 of the nut 210 with the recess 258.

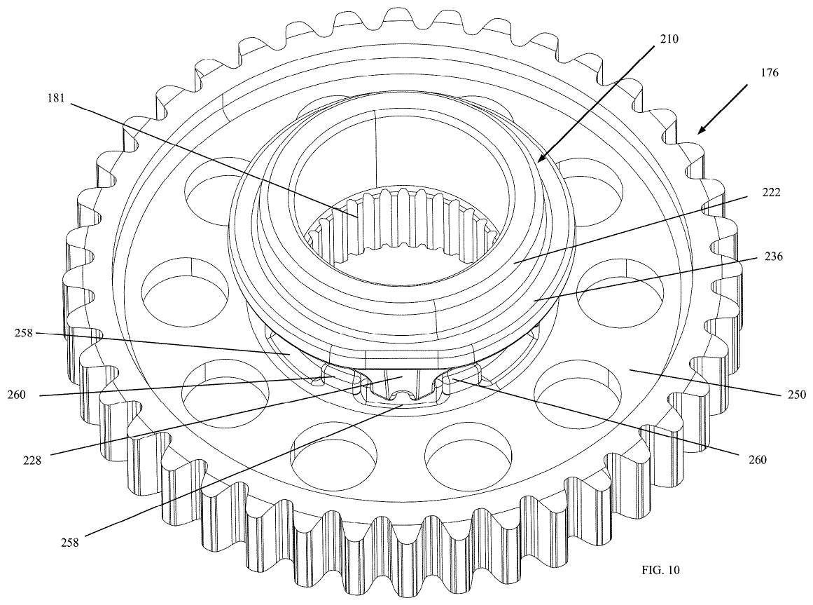

As best seen in FIG. 10, when the projection 228 is received within the recess 258 of the driven belt sprocket 176, relative movement between the nut 210 and the driven belt sprocket 176 is restricted. The nut 210 is rotationally fixed relative to the rear wheel axle 180. Thus, a loosening of the nut 210 from the rear wheel axle 180 is avoided. This has further advantages in that the seal between the main housing portion 154 and the housing cover 156 need not be opened to access the nut 210 in order to check whether the nut 210 has loosened and if so, re-tighten the nut 210.

A method of assembling the nut 210 and the driven belt sprocket 176 onto the rear wheel axle 180 comprises positioning the nut 210 on the rear wheel axle 180 such that the rear wheel axle 180 extends through the nut opening 220, screwing the nut 210 on the rear wheel axle 180 by means of the threads; and positioning the driven belt sprocket 176 such that: the rear wheel axle 180 extends through the sprocket opening 246, the driven belt sprocket 176 is rotationally fixed relative to the rear wheel axle 180; and the projection 228 extending from the left end face 226 of the nut 210 is received in the recess 258 defined in the right end face 250 of the driven belt sprocket 176.

One or more of the alignment indicators 270 are used for positioning the driven belt sprocket 176 relative to the nut 210 such that the projection 228 is received in the recess 258. As each alignment indicator 270 is aligned with a central portion of the corresponding recess 258 on the right end face 250, the driven belt sprocket 176 is positioned so that the alignment indicator 270 is aligned with the projection 228. The person assembling the driven belt sprocket 176 onto the nut 210 need not see the recess 258 to position the projection 228 in the recess 258. During positioning, the internal splines 181 of the driven belt sprocket 176 are aligned with the external splines 191 of the rear wheel axle 180. If required, the nut 210 is further slightly tightened or slightly loosened to align the internal spline 181 of the driven belt sprocket 176 with the middle of the groove 234, so that the projection 228 lines up with the recess 258 of the driven belt sprocket 176, using the alignment indicator 270, which is itself lined up with the spline 181. As best seen in FIG. 6, the nut is screwed until it abuts an abutting surface which in the present embodiment is an inner race of the right bearing 182.

Modifications and improvements to the above-described implementations of the present technology may become apparent to those skilled in the art. For example, the fastener assembly comprising embodiments of the nut 210 and the drive belt sprocket 176 can be used in any other manner other than the drivetrain and the vehicle example provided herein. The foregoing description is intended to be exemplary rather than limiting. The scope of the present technology is therefore intended to be limited solely by the scope of the appended claims.

What is claimed is:

1. A fastener assembly comprising:
a fastener configured to fit around a shaft, the fastener having:
a fastener body having a fastener outer periphery, and a fastener inner periphery defining a fastener opening for receiving the shaft;
an end face being disposed between the fastener inner periphery and the fastener outer periphery;
a retaining member configured to fit around the shaft, the retaining member having:
a retaining member body having a retaining member outer periphery, and a retaining member inner periphery defining a retaining member opening for receiving the shaft; and
an end face disposed between the retaining member outer periphery and the retaining member inner periphery, the end face of the retaining member body facing the end face of the fastener body;
at least one projection extending from one of: the end face of the fastener body and the end face of the retaining member body; and
at least one recess defined in an other of: the end face of the fastener body and the end face of the retaining member body, the at least one recess being sized and shaped to receive the at least one projection.

2. The fastener assembly of claim 1, wherein the inner periphery of the retaining member defines internal splines for engaging external splines defined on the shaft.

3. The fastener assembly of claim 1, wherein at least a portion of the fastener inner periphery defines threads, the threads being configured to engage with a threaded portion of the shaft.

4. The fastener assembly of claim 1, wherein the at least one projection comprises two projections separated by a fastener groove.

5. The fastener assembly of claim 1, wherein the at least one projection extends from the end face of the fastener body and the at least one recess is defined in the end face of the retaining member body.

6. The fastener assembly of claim 5, wherein the at least one projection extends axially from the end face of the fastener.

7. The fastener assembly of claim 5, wherein the at least one recess is positioned radially outwardly from the retaining member inner periphery and extends circumferentially about the end face of the retaining member body.

8. The fastener assembly of claim 5, wherein the retaining member comprises at least one alignment indicator on another end face of the retaining member, the other end face being disposed between the retaining member outer periphery and the retaining member inner periphery opposite the end face, the at least one alignment indicator indicating a position of a predetermined portion of the at least one recess on the end face.

9. The fastener assembly of claim 8, wherein the predetermined portion is an edge portion or a central portion of the at least one recess.

10. The fastener assembly of claim 5, wherein the at least one recess comprises a plurality of recesses formed in the end face of the retaining member body, the plurality of recesses being spaced apart circumferentially by separator members.

11. The fastener assembly of claim 10, wherein each separator member has a width which increases with increasing radial distance from the inner periphery of the retaining member.

12. The fastener assembly of claim 5, wherein the retaining member comprises a plurality of alignment indicators on another end face of the retaining member, the other end face being disposed between the retaining member outer periphery and the retaining member inner periphery opposite the end face, the plurality of alignment indicators indicating a position of an edge portion or a central portion of the at least one recess on the end face.

13. The fastener assembly of claim 5, wherein the fastener body has an other end face between the fastener inner periphery and the fastener outer periphery and opposite the end face, the other end face being configured to abut an object to retain the object, wherein the end face with the at least one projection is not configured to abut the object.

14. The fastener assembly of claim 1, wherein the fastener is an axle nut, the retaining member is a sprocket, and the shaft is a wheel axle.

15. A fastener for a fastener assembly including a retaining member, the fastener comprising:
a fastener body having a fastener outer periphery, a fastener inner periphery defining a fastener opening for receiving a shaft, and an end face disposed between the fastener inner periphery and the fastener outer periphery; and
at least one projection extending from the end face of the fastener body.

16. The fastener of claim 15, wherein the at least one projection extends axially from the end face of the fastener body.

17. The fastener of claim 15, wherein at least a portion of the fastener inner periphery defines threads, the threads being configured to engage with a threaded portion of the shaft.

18. The fastener of claim 17, wherein the fastener is an axle nut and the shaft is a wheel axle.

19. A method for assembling a fastener assembly onto a shaft, the method comprising:
positioning an internally threaded fastener on the shaft such that the shaft extends through a fastener opening of the fastener, the fastener having a body with a fastener outer periphery, a fastener inner periphery defining the fastener opening, an end face disposed between the fastener inner periphery and the fastener outer periphery;
screwing the fastener on the shaft; and
positioning a retaining member on the shaft, the retaining member having a retaining member body with a retaining member outer periphery, a retaining member inner periphery defining the retaining member opening, an end face disposed between the retaining member outer periphery and the retaining member inner periphery, such that:
the shaft extends through a retaining member opening of the retaining member;
the retaining member is rotationally fixed relative to the shaft; and
at least one projection extending from one of: the end face of the fastener body and the end face of the retaining member body is received in at least one recess defined in an other of: the end face of the fastener body and the end face of the retaining member body.

20. The method of claim 19, wherein the at least one projection extends from the end face of the fastener body and the at least one recess is defined in the end face of the retaining member body, and positioning the retaining member comprises aligning an alignment indicator on another end face of the retaining member body with the at least one projection of the fastener, the other end face being disposed between the retaining member outer periphery and the retaining member inner periphery opposite the end face, and optionally wherein positioning the retaining member comprises engaging internal splines of the retaining member with external splines of the shaft.
